(19) United States
(12) Patent Application Publication
(10) Pub. No.: US 2025/0139454 A1
(43) Pub. Date: May 1, 2025

(54) MULTI-MANIFOLD EMBEDDING LEARNING METHOD AND SYSTEM

(71) Applicants: Inventec (Pudong) Technology Corporation, Shanghai (CN); INVENTEC CORPORATION, TAIPEI CITY (TW)

(72) Inventors: Jeng-Lin LI, TAIPEI CITY (TW); Wei-Chao CHEN, TAIPEI CITY (TW); Ming-Ching CHANG, TAIPEI CITY (TW)

(21) Appl. No.: 18/415,620

(22) Filed: Jan. 17, 2024

(30) Foreign Application Priority Data
Oct. 25, 2023 (CN) 202311395891.0

(51) Int. Cl. G06N 3/0985

(52) U.S. Cl. CPC G06N 3/0985

(57) ABSTRACT

The present disclosure provides a multi-manifold embedding learning method, which includes steps as follows. The ID training data are used to train the multi-manifold embedding learning model, and then the parameters of the multi-manifold embedding learning model are frozen to obtain the trained multi-manifold embedding learning model; the test data are fed to the trained multi-manifold embedding learning model, so as to use a threshold to distinguish out-of-distribution samples from ID samples.

### RELATED APPLICATIONS

This application claims priority to China Patent Application No. 202311395891.0, filed Oct. 25, 2023, the entirety of which is herein incorporated by reference.

### BACKGROUND

### Field of Invention

The present invention relates to computer systems and operation methods thereof, and more particularly, multi-manifold embedding learning method and system.

### Description of Related Art

Machine learning is one of ways to realize artificial intelligence, which is, using machine learning as a means to solve some problems in artificial intelligence.

In data-driven machine learning (ML), out-of-distribution (OOD) samples are unseen instances that do not belong to the distribution where the ML models have been trained on. The deployment of artificial intelligence (AI) models often encounters OOD challenges, due to the domain shifts of test data when compared with the original training data. Such shift can make the trained models over-confident on incorrect decisions, which leads to trustworthy and reliability issues. However, detecting the OOD samples from the in-distribution (ID) data has been a difficult task owing to the nature of the vast OOD sample space than the ID data.

### SUMMARY

In one or more various aspects, the present disclosure is directed to a multi-manifold embedding learning method and a multi-manifold embedding learning system.

One embodiment of the present disclosure is related to a multi-manifold embedding learning method includes steps of: using an ID (identity) training data train a multi-manifold embedding learning model, and freezing parameters of the multi-manifold embedding learning model to obtain a trained multi-manifold embedding learning model; feeding a test data to the trained multi-manifold embedding learning model, so as to use a threshold to distinguish OOD (out-of-distribution) samples from ID samples.

In one embodiment of the present disclosure, the multi-manifold embedding learning method further includes: initializing a plurality of branches of the multi-manifold embedding learning model, so as to encode different manifolds.

In one embodiment of the present disclosure, the branches include a hypersphere branch and a hyperbolic branch, and the different manifolds include a hypersphere manifold and a hyperbolic manifold.

In one embodiment of the present disclosure, the step of using the ID training data train a multi-manifold embedding learning model, and freezing parameters of the multi-manifold embedding learning model to obtain a trained multi-manifold embedding learning model includes: for each training iteration, extracting an embedding of each of the different manifolds, computing a loss correspondingly, and updating the multi-manifold embedding learning model based on the loss; after the multi-manifold embedding learning model is trained, freezing the parameters of the multi-manifold embedding learning model to obtain the trained multi-manifold embedding learning model; and feeding the ID training data to the trained multi-manifold embedding learning model to extract an ID reference embedding.

In one embodiment of the present disclosure, the loss includes losses of the different manifolds and a cross-entropy classification loss.

In one embodiment of the present disclosure, the step of feeding the test data to the trained multi-manifold embedding learning model, so as to use the threshold to distinguish the OOD samples from the ID samples includes: feeding the test data to the trained multi-manifold embedding learning model to extract a latent embedding; computing a OOD score based on a distance between the latent embedding and the ID reference embedding; and comparing the OOD score to the threshold to perform a OOD detection, and the OOD detection distinguishes the OOD samples from the ID samples in the test data.

Another embodiment of the present disclosure is related to a multi-manifold embedding learning system that includes a storage device and a processor. The storage device is configured to store at least one instruction. The processor is coupled to the storage device, and the processor is configured to access and execute the at least one instruction for: initializing a plurality of branches of a multi-manifold embedding learning model, so as to encode different manifolds; using an ID training data train the multi-manifold embedding learning model, and freezing parameters of the multi-manifold embedding learning model to obtain a trained multi-manifold embedding learning model; and feeding a test data to the trained multi-manifold embedding learning model, so as to use a threshold to distinguish OOD (out-of-distribution) samples from ID samples.

In one embodiment of the present disclosure, the processor accesses and executes the at least one instruction for: for each training iteration, extracting an embedding of each of the different manifolds, computing a loss correspondingly, and updating the multi-manifold embedding learning model based on the loss; after the multi-manifold embedding learning model is trained, freezing the parameters of the multi-manifold embedding learning model to obtain the trained multi-manifold embedding learning model; and feeding the ID training data to the trained multi-manifold embedding learning model to extract an ID reference embedding.

In one embodiment of the present disclosure, the processor accesses and executes the at least one instruction for: feeding the test data to the trained multi-manifold embedding learning model to extract a latent embedding; computing a OOD score based on a distance between the latent embedding and the ID reference embedding; and comparing the OOD score to the threshold to perform a OOD detection, and the OOD detection distinguishes the OOD samples from the ID samples in the test data.

In one embodiment of the present disclosure, the branches include a hypersphere branch and a hyperbolic branch, the different manifolds include a hypersphere manifold and a hyperbolic manifold, and the loss includes a hypersphere loss, a hyperbolic loss and a cross-entropy classification loss.

Technical advantages are generally achieved, by embodiments of the present disclosure. The multi-manifold embedding learning method and the multi-manifold embedding learning system aim to detect OOD samples to avoid the unreliable prediction results of the models and the present disclosure thus introduce a novel Multi-Manifold Embedding Learning (MMEL) model, to incorporate both manifolds with positive and negative curvatures to enhance the latent representations for OOD samples. By jointly learning multiple manifolds using multitask losses, the framework of the present disclosure seeks to increase the heterogeneity of the embedding space, thereby avoiding distorted representation relations when dealing with unknown OOD samples.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a schematic diagram of a multi-manifold embedding learning method according to one embodiment of the present disclosure;

FIG. 2 is a flow chart of a multi-manifold embedding learning method according to one embodiment of the present disclosure; and

FIG. 3 is a block diagram of a multi-manifold embedding learning system according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

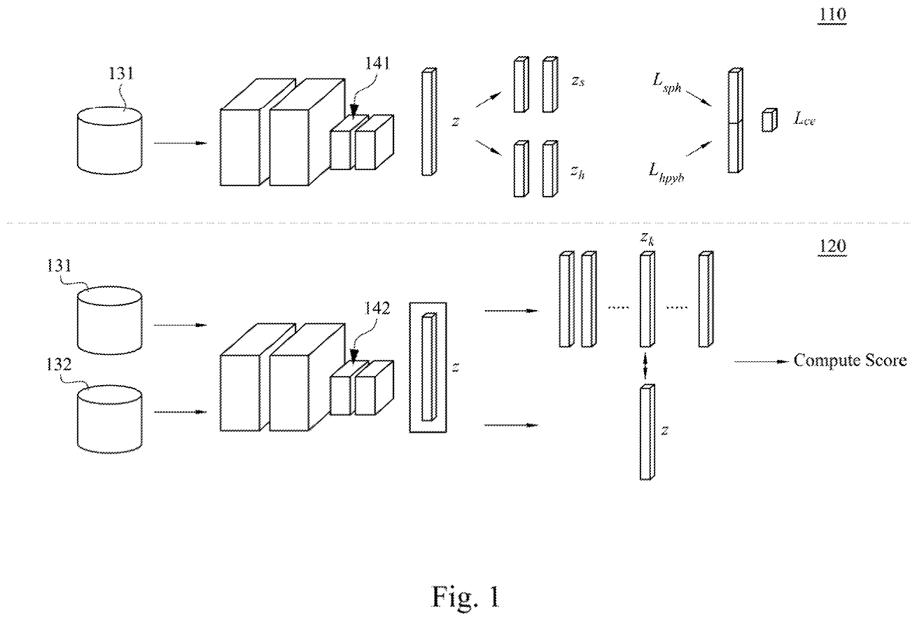

Referring to FIG. 1, in one aspect, the present disclosure is directed to a multi-manifold embedding learning method. This method may be easily integrated into artificial intelligence and may be applicable or readily adaptable to all technologies. Accordingly, the multi-manifold embedding learning method has advantages. Herewith the multi-manifold embedding learning method is described below with FIG. 1.

The subject disclosure provides the multi-manifold embedding learning method in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

FIG. 1 is a schematic diagram of a multi-manifold embedding learning method according to one embodiment of the present disclosure. As shown in FIG. 1, the multi-manifold embedding learning method includes a training phase 110 and a testing phase 120.

In the training phase 110, the ID (identity) training data 131 is used to train the multi-manifold embedding learning model 141, and then the parameters of the multi-manifold embedding learning model 141 are frozen to obtain the trained multi-manifold embedding learning model 142. In the testing phase 120, the test data 132 is fed to the trained multi-manifold embedding learning model 142, so as to use a threshold to distinguish OOD (out-of-distribution) samples from ID samples.

Specifically, in some embodiments of the present disclosure, in the training phase 110, a plurality of branches of the multi-manifold embedding learning model 141 are initialized, so as to encode different manifolds. In practice, for example, the branches include a hypersphere branch and a hyperbolic branch, and the different manifolds include a hypersphere manifold and a hyperbolic manifold. The present disclosure incorporates both manifolds with positive and negative curvatures in the multi-manifold embedding learning model 141, so as to enhance the latent representations of the trained multi-manifold embedding learning model 142 for OOD samples.

Then, in the training phase 110, for each training iteration, an embedding z of each of the different manifolds is extracted, a loss is computed correspondingly, and the multi-manifold embedding learning model 141 is updated based on the loss. After the multi-manifold embedding learning model 141 is trained, the parameters of the multi-manifold embedding learning model 141 are frozen to obtain the trained multi-manifold embedding learning model 142.

In some embodiments of the present disclosure, the loss includes losses of the different manifolds and a cross-entropy classification loss L_{ce}. In practice, for example, the embedding z includes an embedding zₛ of the hypersphere manifold and an embedding zₕ of the hyperbolic manifold. The corresponding loss of the embedding zₛ of the hypersphere manifold is a hypersphere loss Lₛₚₕ, and The corresponding loss of the embedding zₕ of the hyperbolic manifold is a hyperbolic loss L_{hypb}.

Then, in the testing phase 120, in some embodiments of the present disclosure, the ID training data 131 is fed to the trained multi-manifold embedding learning model 142 to extract an ID reference embedding zₖ; the test data 132 is fed to the trained multi-manifold embedding learning model 142 to extract a latent embedding z; a OOD score is computed based on a distance between the latent embedding z and the ID reference embedding zₖ; and the OOD score is compared to the threshold to perform a OOD detection, in which the OOD detection distinguishes the OOD samples from the ID samples in the test data 132.

In view of above, the present disclosure use the hypersphere embedding, hyperbolic embedding, and multiple manifold learning to discuss the related technical fields using the following notations. Input data x∈X are fed into a model f: X→Y to predict label y∈Y^{ID}, where ID denotes in-distribution and Y^{ID}=\{y₁, y₂, . . . , y_{K}\} with K classes. Model f is trained using ID training data x drawn from the marginal distribution P_{X}^{ID} and yields the latent embedding z. The present disclosure aims to detect OOD samples from P_{X}^{OOD} during inference, where the corresponding OOD label space is potentially out of the Y^{ID} range. The OOD detection is carried out using an estimator g based on a scoring function S(z) and a threshold λ as follows.

$${g}_{λ} ( z ) = \{ \begin{matrix}ID & if S ( z ) \leq λ \\ OOD & otherwise\end{matrix}$$

In some embodiments of the present disclosure, the standard steps to detect OOD are as follows: (1) training a model (e.g., the multi-manifold embedding learning model 141) with the ID training data and freeze the model parameters; (2) inputting testing data to the frozen model (e.g., the trained multi-manifold embedding learning model 142); (3) calculating the OOD score and differentiate OOD samples with the threshold.

As to the hyperbolic manifold, in some embodiments of the present disclosure, the present disclosure uses CIDER to optimize compactness and disparity losses for a hypersphere manifold which is represented by the von Mises-Fisher (vMF) distribution with a unit vector zₛ∈Rₛ^{d} in class k and the class prototype μₖ:p_{d}(zₛ;μₖ)=τexp(μ_{kz}_{ₛ}/τ), where τ is a temperature parameter. The probability of the embedding zₛ assigned to class k is as follows.

$$P ( y = k \vert {z}_{s} ; ∖ \{ {μ}_{k} , τ ∖ \} ) = \frac{exp ( {μ}_{k {z}_{s}} / τ )}{{\sum }_{j = 1}^{K} exp ( {μ}_{j {z}_{S}} / τ )} .$$

Taking negative log-likelihood, the present disclosure derives the compactness loss which forces each sample to locate close to the prototypes of the belonging class.

$${L}_{com} = \frac{- 1}{N} log \frac{exp ( {μ}_{k {z}_{s}} / τ )}{{\sum }_{j = 1}^{K} exp ( {μ}_{j {z}_{s}} / τ )} .$$

The disparity loss encourages a large angular margin among class prototypes as follows.

$${L}_{dis} = \frac{- 1}{K} {\sum }_{i = 1}^{K} log \frac{1}{K - 1} {\sum }_{j = 1}^{K} {1}_{j i} exp ( {μ}_{i {μ}_{j}} / τ ) ,$$

In above, 1ⱼᵢ is indication function

$${1}_{j i} = \{ \begin{matrix}1 & if j \neq i \\ 0 & otherwise\end{matrix} .$$

The loss function for the hypersphere branch can be expressed as Lₛₚₕ=L_{com}+L_{dis}. These two losses jointly shape the clusters on the hypersphere with intra-class compactness and inter-class disparity for ID data, and OOD data have less chance to locate in the space near ID prototypes.

As to the hyperbolic manifold, in some embodiments of the present disclosure, a hyperbolic space is a combination of Riemannian manifolds with constant negative curvature, where the curvature indicates the deviation from the Euclidean space. A set of models are formulated for isomorphic transformation between the hyperbolic space in that the space cannot be isometrically embedded into Euclidean space. One of the majority models, Poincaré Ball (M_{c}^{d}, g^{M}), defines a manifold M^{d}=\{u∈R^{d}:c∥u∥<1\} equipped with the Riemannian metric

$${g}^{M} ( u ) = {( {λ}_{u}^{c} )}^{2} {g}^{E} = {( \frac{2}{1 - c {‖ u ‖}^{2}} )}^{2} I , \\ where λ = \frac{2}{1 - c {‖ u ‖}^{2}}$$

is a conformal factor with curvature c and g^{E}=I is an Euclidean metric tensor. The manifold depends on the operations with Mobius gyrovector space including the Mobius addition ⊕_{c} and scalar multiplication ⊗_{c}, where u and v are vectors and w is a scalar.

$$u {⊕}_{c} v = \frac{( 1 + 2 c 〈 u , v 〉 + c {‖ v ‖}^{2} ) u + ( 1 - c {‖ u ‖}^{2} ) v}{1 + 2 c 〈 u , v 〉 + {c}^{2} {‖ u ‖}^{2} {‖ v ‖}^{2}} , w {⊕}_{c} u = \frac{1}{\sqrt{c}} tanh ( w \cdot arctan h ( \sqrt{c} ‖ u ‖ ) ) ,$$

The geometric distance between two points u and v is written in the following form.

$$D ( u , v ) = \frac{2}{\sqrt{c}} arc tan h ( \sqrt{c} ‖ - u {⊕}_{c} v ‖ ) .$$

The distance converges to 2∥u−v∥ with the curvature c→0 which is proportional to the case for Euclidean distance.

An Exponential map can transform a vector to the tangent space on the Poincaré ball. The present disclosure is to generate the embedding vector v using a backbone network and transform the vector as the hyperbolic embedding with the exponential map

$${ε}^{c} ( v ) = tanh ( \sqrt{c} ‖ v ‖ ) \frac{v}{\sqrt{c} ‖ v ‖} .$$

Then, the present disclosure can derive Hyperbolic averaging with multiple hyperbolic embeddings via Einstein midpoint. The present disclosure can project the embedding from the Poincaré ball D_{c}^{d} to the Klein model K_{c}^{d} and calculate a simpler average form with the Klein coordinate as follows.

$${u}_{K} = \frac{2 {u}_{D}}{1 + c {‖ {u}_{D} ‖}^{2}} , \\ \overline{{u}_{K}} = \frac{{\sum }_{i = 1}^{m} {r}_{{iu}_{K , i}}}{{\sum }_{i = 1}^{m} {r}_{i}} ,$$

In above, rᵢ is the Lorentz factor. After deriving the average embedding in the Klein coordinate, the present disclosure transforms the space back to the Poincaré ball as follows.

$$\overline{{u}_{D}} = \frac{\overline{{u}_{K}}}{1 + \sqrt{1 - c {‖ \overline{{u}_{K}} ‖}^{2}}}$$

With the available operations of the hyperbolic space, the present disclosure is to project the latent embedding with a hyperbolic head to derive the embedding u on the Poincaré ball. With an augmented set A from X to form a full set I=A∩x, the supervised contrastive loss is calculated on the positive sample p(i) of the i∈I in contrast to other augmented samples a∈A. Supervised hyperbolic contrastive loss can thus be formulated as follows.

$${L}_{hypb} = - {\sum }_{i ∈ I} \frac{1}{\vert P ( i ) \vert} {\sum }_{p ∈ P ( i )} log \frac{exp ( - D ( {z}_{i} , {z}_{{h}_{p}} ) / τ )}{{\sum }_{a ∈ A} exp ( - D ( {z}_{{h}_{i}} , {z}_{{h}_{a}} ) / τ )} .$$

As to optimization details, the final loss is the combination of the hypersphere and hyperbolic losses along with a cross-entropy loss L_{ce} to optimize for ID classification accuracy as follows.

$$L = {L}_{sph} + {L}_{hypb} + {L}_{ce}$$

The curvature parameter c is usually deemed as a hyperparameter. The present disclosure employs the Gromov measurement to estimate the c value.

For the stability of learning, the present disclosure adopts the feature clipping technique that is empirically found useful for better convergence and to avoid the gradient vanishing of complex manifold learning. An Euclidean space sample point x is truncated as the clipped feature

$${x}^{′} = min ∖ \{ 1 , \frac{r}{‖ x ‖} ∖ \} \cdot x$$

with the effective radius r of the Poincaré ball. This process regularizes the points sitting overly close to the ball boundary.

As to the OOD scoring function, with a trained network f in the MMEL framework (e.g., the trained multi-manifold embedding learning model 142), the present disclosure extracts the penultimate layer output as an L2 normalized embedding z of the sample x for its OOD score computation. To differentiate between OOD samples and ID samples, the present disclosure calculates the embedding distance between each input sample and the training ID samples and specify the k-th nearest neighbor as a reference embedding zₖ. The present disclosure obtains the OOD score based on the L2 distance, S(z)=∥z−zₖ∥². The OOD detection is thus realized by compare this threshold to the threshold λ.

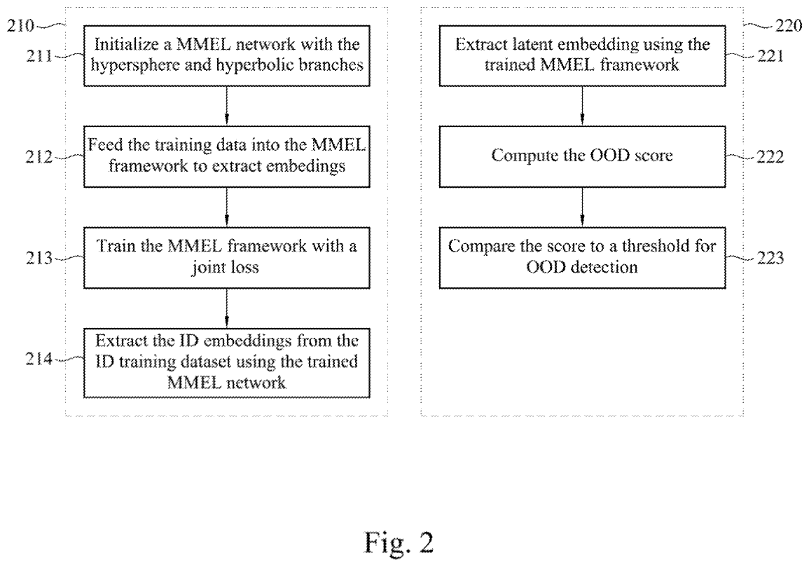

FIG. 2 is a flow chart of a multi-manifold embedding learning method 200 according to one embodiment of the present disclosure. As shown in FIG. 2, the multi-manifold embedding learning method 200 includes a training phase 210 and a testing phase 220. The training phase 210 includes steps 211-214, and the testing phase 220 includes steps 221-223. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The multi-manifold embedding learning method 200 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In the training phase 210, in step 211, the MMEL framework is initialized with hypersphere and hyperbolic branches. Specifically, in some embodiments of the present disclosure, in step 211, the hypersphere and hyperbolic branches of the multi-manifold embedding learning model are initialized, so as to encode hypersphere and hyperbolic manifolds with different curvatures.

In step 212, the training data is Fed into the MMEL framework to extract embeddings. Specifically, in some embodiments of the present disclosure, in step 212, for each training iteration, an embedding of the hypersphere manifold and an embedding of the hyperbolic manifold are extracted.

In step 213, the MMEL framework is trained with a joint loss. In some embodiments of the present disclosure, in step 212, for each training iteration, a hypersphere loss of the embedding of the hypersphere manifold, a hyperbolic loss of the embedding of the hyperbolic manifold and a cross-entropy classification loss are summed as a joint loss so as to update the multi-manifold embedding learning model. For example, the weight value and/or shift value of each simulated neuron in the multi-manifold embedding learning model is adjusted until the joint loss is less than the preset loss value, but the present disclosure is not limited to this example.

In step 214, the ID embeddings are extracted from the ID training dataset using the trained MMEL network. Specifically, in some embodiments of the present disclosure, in step 214, the ID training data is fed to the trained multi-manifold embedding learning model to extract an ID reference embedding.

In the testing phase 220, in step 221, the latent embedding is extracted by using the trained MMEL framework. In some embodiments of the present disclosure, in step 221, the test data is fed to the trained multi-manifold embedding learning model to extract the latent embedding.

In step 222, the OOD score is computed. In some embodiments of the present disclosure, in step 222, the OOD score is computed based on a distance between the latent embedding and the ID reference embedding.

In step 223, the score is compared to a threshold for the OOD detection. In some embodiments of the present disclosure, in step 223, the OOD score is compared to the threshold to perform the OOD detection, and the OOD detection distinguishes the OOD samples from the ID samples in the test data. When the OOD score is approximately less than or equal to the threshold, it is determined to be an ID sample; conversely, when the OOD score is approximately greater than the threshold, it is determined to be an OOD sample. In practice, for example, the specific value of the threshold can be flexibly set based on experimental data or empirical data.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

For a more complete understanding of hardware for performing the multi-manifold embedding learning method, referring FIGS. 1-3, FIG. 3 is a block diagram of a multi-manifold embedding learning system 300 according to one embodiment of the present disclosure.

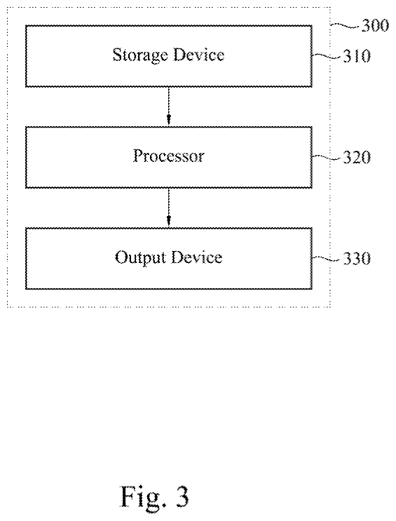

As shown in FIG. 3, the multi-manifold embedding learning system 300 includes a storage device 310, a processor 320 and an output device 330. For example, the multi-manifold embedding learning system 300 can be a computer device, the storage device 310 can be a hard disk, a flash memory or another storage media, the processor 320 can be a central processing unit, and the output device 330 can be a display device or a communication device.

In structure, the storage device 310 is electrically connected to the processor 320, and the processor 320 is electrically connected to the output device 330. It should be noted that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. For example, the storage device 310 may be a built-in storage device that is directly connected to the processor 320, or the storage device 310 may be an external storage device that is indirectly connected to the processor 320 through the network device.

In use, the storage device is configured to store at least one instruction 310, and the processor 320 is configured to access and execute the at least one instruction for performing steps and functions of the multi-manifold embedding learning method of FIG. 1 and/or the multi-manifold embedding learning method 200.

In some embodiments of the present disclosure, the processor 320 is configured to access and execute the at least one instruction for: initializing a plurality of branches of a multi-manifold embedding learning model, so as to encode different manifolds; using an ID training data train the multi-manifold embedding learning model, and freezing parameters of the multi-manifold embedding learning model to obtain a trained multi-manifold embedding learning model; and feeding a test data to the trained multi-manifold embedding learning model, so as to use a threshold to distinguish OOD (out-of-distribution) samples from ID samples.

In some embodiments of the present disclosure, the processor 320 accesses and executes the at least one instruction for: for each training iteration, extracting an embedding of each of the different manifolds, computing a loss correspondingly, and updating the multi-manifold embedding learning model based on the loss; after the multi-manifold embedding learning model is trained, freezing the parameters of the multi-manifold embedding learning model to obtain the trained multi-manifold embedding learning model; and feeding the ID training data to the trained multi-manifold embedding learning model to extract an ID reference embedding.

In some embodiments of the present disclosure, the processor 320 accesses and executes the at least one instruction for: feeding the test data to the trained multi-manifold embedding learning model to extract a latent embedding; computing a OOD score based on a distance between the latent embedding and the ID reference embedding; and comparing the OOD score to the threshold to perform a OOD detection, and the OOD detection distinguishes the OOD samples from the ID samples in the test data. The output device 330 can be a display device to present the results of the OOD detection.

In a controlled experiment, the computer device executes other machine learning methods (such as methods based on PyTorch-OOD, methods based on traditional embedding, etc.) to perform OOD detection, where the method based on PyTorch-OOD can be, for example, MaxSoftmax, Mahalanobis, ODIN, Energy, Entropy, VIM, KLMatching and so on; methods based on traditional embedding can be, for example, SSD, KNN+, CIDER and so on. Compared with other machine learning methods mentioned above, the multi-manifold embedding learning method of the present disclosure has both a lower false positive rate (FPR) and a better area under the receiver operating characteristic curve (AUC) for the OOD detection. Thus, compared with other machine learning methods mentioned above, the multi-manifold embedding learning method of the present disclosure can more accurately distinguish OOD samples from ID samples.

In view of the above, technical advantages are generally achieved, by embodiments of the present disclosure. The multi-manifold embedding learning method 200 and the multi-manifold embedding learning system 300 aim to detect OOD samples to avoid the unreliable prediction results of the models and the present disclosure thus introduce a novel Multi-Manifold Embedding Learning (MMEL) model, to incorporate both manifolds with positive and negative curvatures to enhance the latent representations for OOD samples. By jointly learning multiple manifolds using multitask losses, the framework of the present disclosure seeks to increase the heterogeneity of the embedding space, thereby avoiding distorted representation relations when dealing with unknown OOD samples.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A multi-manifold embedding learning method, comprising steps of:
using an ID (identity) training data train a multi-manifold embedding learning model, and freezing parameters of the multi-manifold embedding learning model to obtain a trained multi-manifold embedding learning model; and
feeding a test data to the trained multi-manifold embedding learning model, so as to use a threshold to distinguish OOD (out-of-distribution) samples from ID samples.

2. The multi-manifold embedding learning method of claim 1, further comprising:
initializing a plurality of branches of the multi-manifold embedding learning model, so as to encode different manifolds.

3. The multi-manifold embedding learning method of claim 2, wherein the branches comprise a hypersphere branch and a hyperbolic branch, and the different manifolds comprise a hypersphere manifold and a hyperbolic manifold.

4. The multi-manifold embedding learning method of claim 2, wherein the step of using the ID training data train a multi-manifold embedding learning model, and freezing parameters of the multi-manifold embedding learning model to obtain a trained multi-manifold embedding learning model comprises:
for each training iteration, extracting an embedding of each of the different manifolds, computing a loss correspondingly, and updating the multi-manifold embedding learning model based on the loss;
after the multi-manifold embedding learning model is trained, freezing the parameters of the multi-manifold embedding learning model to obtain the trained multi-manifold embedding learning model; and
feeding the ID training data to the trained multi-manifold embedding learning model to extract an ID reference embedding.

5. The multi-manifold embedding learning method of claim 4, wherein the loss comprises losses of the different manifolds and a cross-entropy classification loss.

6. The multi-manifold embedding learning method of claim 4, wherein the step of feeding the test data to the trained multi-manifold embedding learning model, so as to use the threshold to distinguish the OOD samples from the ID samples comprises:
feeding the test data to the trained multi-manifold embedding learning model to extract a latent embedding;
computing a OOD score based on a distance between the latent embedding and the ID reference embedding; and
comparing the OOD score to the threshold to perform a OOD detection, and the OOD detection distinguishes the OOD samples from the ID samples in the test data.

7. A multi-manifold embedding learning system, comprising:
a storage device configured to store at least one instruction; and
a processor coupled to the storage device, and the processor configured to access and execute the at least one instruction for:
initializing a plurality of branches of a multi-manifold embedding learning model, so as to encode different manifolds;
using an ID training data train the multi-manifold embedding learning model, and freezing parameters of the multi-manifold embedding learning model to obtain a trained multi-manifold embedding learning model; and
feeding a test data to the trained multi-manifold embedding learning model, so as to use a threshold to distinguish OOD (out-of-distribution) samples from ID samples.

8. The multi-manifold embedding learning system of claim 7, wherein the processor accesses and executes the at least one instruction for:
for each training iteration, extracting an embedding of each of the different manifolds, computing a loss correspondingly, and updating the multi-manifold embedding learning model based on the loss;
after the multi-manifold embedding learning model is trained, freezing the parameters of the multi-manifold embedding learning model to obtain the trained multi-manifold embedding learning model; and
feeding the ID training data to the trained multi-manifold embedding learning model to extract an ID reference embedding.

9. The multi-manifold embedding learning system of claim 8, wherein the processor accesses and executes the at least one instruction for:
feeding the test data to the trained multi-manifold embedding learning model to extract a latent embedding;
computing a OOD score based on a distance between the latent embedding and the ID reference embedding; and
comparing the OOD score to the threshold to perform a OOD detection, and the OOD detection distinguishes the OOD samples from the ID samples in the test data.

10. The multi-manifold embedding learning system of claim 8, wherein the branches comprise a hypersphere branch and a hyperbolic branch, the different manifolds comprise a hypersphere manifold and a hyperbolic manifold, and the loss comprises a hypersphere loss, a hyperbolic loss and a cross-entropy classification loss.
